(19) United States
(12) Patent Application Publication
(10) Pub. No.: US 2017/0009870 A1
(43) Pub. Date: Jan. 12, 2017

(54) MECHANISM HOUSING FOR AN ADJUSTMENT MECHANISM FOR A VEHICLE SEAT

(71) Applicant: JOHNSON CONTROLS METALS AND MECHANISMS GMBH & CO. KG, Solingen (DE)

(72) Inventor: Andreas HOFFMANN, Wülfrath (DE)

(73) Assignee: JOHNSON CONTROLS METALS AND MECHANISMS GMBH & CO. KG, Solingen (DE)

(21) Appl. No.: 15/115,433

(22) PCT Filed: Jan. 27, 2015
(86) PCT No.: PCT/EP2015/051564

§ 371 Date: Jul. 29, 2016

(30) Foreign Application Priority Data
Jan. 31, 2014 (DE) 10 2014 201 813.7
Mar. 10, 2014 (DE) 10 2014 204 301.8

(51) Int. Cl. F16H 57/023; F16H 57/039; B60N 2/02; B60N 2/06; B60N 2/44; F16B 2/24

(52) U.S. Cl. CPC F16H 57/023; B60N 2/443; F16B 2/241; F16B 2/248; B60N 2/02; B60N 2/067; F16H 57/039; F16H 2025/2031

(57) ABSTRACT

A mechanism housing (140) for an adjustment mechanism (100) for a vehicle seat includes a first housing part (150) and a second housing part (160). A first cylinder segment (155) of the first housing part (150) and a second cylinder segment (165) of the second housing part (160) join as a pair to form a cylinder portion (170) through which a spindle (4) extending along an axis (A) can be passed. In the radial direction relative to the axis (A), facing away from each other, the two housing parts (150, 160) are held together by two spring clips (180).

### CROSS REFERENCE TO RELATED APPLICATIONS

This application is a United States National Phase Application of International Application PCT/EP2015/051564 filed Jan. 27, 2015 and claims the benefit of priority under 35 U.S.C. §119 of German Applications 10 2014 201 813.7 filed Jan. 31, 2014 and 10 2014 204 301.8 filed Mar. 10, 2014, the entire contents of which are incorporated herein by reference.

### FIELD OF THE INVENTION

The invention relates to a mechanism housing for an adjustment mechanism for a vehicle seat, having a first housing part and a second housing part.

### BACKGROUND OF THE INVENTION

WO 2005/053997 A1 discloses a mechanism housing for a seat adjustment mechanism having a first housing part and a second housing part, in which the two housing parts are fixed in position relative to one another by means of a screwed connection.

DE 10 2008 046 274 A1 describes a screw adjustment mechanism having a housing surrounding a nut screwed onto a screw, said housing consisting of two housing parts which can be joined together from each side of the nut in the longitudinal direction of the screw and connected and held in the assembled condition by means of a flexible coupling element. In this arrangement, the coupling element exerts on the housing parts an elastic prestress which pushes the housing parts toward the nut in the longitudinal direction of the screw.

EP 1 026 027 A2 discloses a mechanism housing for a seat adjustment mechanism, said housing comprising a first half shell and a second half shell. Formed integrally on the first half shell are pegs, which are inserted into complementary openings in the second half shell. In the direction of the pegs, the two half shells are secured relative to one another by a U-shaped shell receptacle, the two ends of which are formed in a fork-shaped manner in the form of an open wrench aperture. Each of the fork-shaped ends surrounds a semicircular shoulder formed by the first half shell and the second half shell and thereby fixes the two half shells relative to one another in the direction of the pegs. To insert the mechanism housing into the shell receptacle, the mechanism housing must first of all be twisted through 90° relative to its final installation position for insertion into the shell receptacle and then rotated into its final installation position. This is necessary to ensure that the two semicircular shoulders can pass the narrow points in the wrench-aperture-shaped ends of the shell receptacle. In the final installation position, the mechanism housing is then secured positively in the shell receptacle.

### SUMMARY OF THE INVENTION

The problem underlying the invention is to improve a mechanism housing of the type stated at the outset, in particular to reduce assembly costs. The intention is to eliminate rotation, during the assembly process, of the mechanism housing within a receptacle that supports the mechanism housing.

According to the invention, this object is achieved by a mechanism housing having a first housing part and a second housing part, in which the two housing parts are fixed relative to one another in at least one spatial direction by means of at least one spring clip.

By virtue of the fact that the two housing parts are fixed relative to one another in at least one spatial direction by means of at least one spring clip, a reduction in production costs through simplification of the individual parts and of the manufacturing processes is achieved. Moreover, a reduction in component size through installation space optimization of the connecting elements is possible as compared with screwed mechanism housings. It is possible to eliminate rotation, during the assembly process, of the mechanism housing within a receptacle that supports the mechanism housing since the two housing parts are already secured relative to one another by the spring clip.

The spring clip fixes the two housing parts relative to one another in at least one spatial direction. Fixing in the other spatial directions is preferably accomplished by means of stepped contact surfaces of the housing parts which rest on one another. The contact surfaces are preferably stepped in such a way that, by virtue of the stepped contact surfaces alone, the two housing parts can be moved relative to one another in only one spatial direction. The at least one spring clip then secures the two housing parts in this one spatial direction. Stepped contact surfaces are known from WO 2005/053997 A1, for example.

The invention is not restricted to the mechanism housing consisting of precisely two housing parts. In addition to the first housing part and the second housing part, the mechanism housing can also have one or more further housing parts.

The mechanism housing can form an accommodation space for a spindle nut, which can be rotated about an axis, and a worm, which drives the spindle nut. The rotation of the spindle nut brings about a movement of the mechanism housing relative to a spindle interacting with the spindle nut, said spindle extending in the direction of the axis. Such spindle-nut mechanisms can be employed in seat adjustment mechanisms for longitudinal seat adjusters, for example.

In a preferred embodiment, the spring clip has a flat U-shaped basic shape. Such a shape can be punched or bent easily. However, the spring clip can also have a slightly arched shape, in particular a wave shape, allowing the direction of the resulting contact forces to be selectively influenced at contact points between the spring clip and the mechanism housing.

Thus, for example, it is possible to produce resultant forces which have a force component that pushes the spring clip constantly in the fitting direction of the spring clip.

A suitable spring characteristic can be achieved if the spring clip has two spring legs that are connected to one another by a web. In this case, the web can connect one end of each of the two spring legs to one another or can be arranged between the ends of the two spring legs.

The two spring legs can be formed in mirror symmetry with respect to one another. Symmetrical force distribution in the spring support on the mechanism housing is thereby obtained.

The spring clip is preferably punched out of a spring sheet. However, the spring clip can also be bent from a spring wire.

In a preferred embodiment, the spring clip engages around a shoulder on the mechanism housing, wherein the shoulder is composed of at least two segments, and each of the two segments is formed integrally on a different one of the two housing parts. The shoulder can be a cylindrical portion consisting of a first cylindrical segment of the first housing part and of a second cylindrical segment of the second housing part, which rest on one another and complement one another to form the cylindrical portion. The cylindrical portion is preferably a hollow cylindrical portion. The cylindrical portion is preferably a hollow cylindrical portion through which a spindle interacting with the spindle nut passes. Here, the centerlines of the hollow cylinder and of the spindle can coincide. The mechanism housing preferably has precisely two shoulders, of which each shoulder interacts with precisely one spring clip.

During the assembly of the mechanism, the spring clip is preferably pushed onto the shoulder of the mechanism housing, in particular onto a shoulder designed as a cylindrical portion, which is composed of two cylindrical segments, each of which is formed integrally on a different one of the two housing parts. As the spring clip is pushed on, the two spring legs spread open slightly in a resilient manner, with a contoured portion of each spring leg running along the shoulder, in particular along a bottom of a depression in the shoulder. After the final position relative to the mechanism housing has been reached, the spring legs preferably spring back together slightly, wherein individual contours of the spring arms interact nonpositively and/or positively with contours of the shoulder. At least one of the two spring legs can have a boss on an end remote from the web, said boss fixing the spring clip counter to a fitting direction of the spring clip. In this way, the spring clip can be secured against loss without additional retention means. Retention of the spring clip in the axial direction can be achieved if at least one spring leg engages in a depression of a shoulder. As a result, this spring leg rests between two lateral boundary surfaces of the depression. The depression preferably extends in a tangential direction.

The two spring legs preferably enclose between them a boss region of the mechanism housing in such a way that the boss region prevents twisting of the spring clip, in particular around a shoulder designed as a cylindrical portion. The boss can project in a radial direction from the shoulder. The boss can have a cuboidal configuration and engage positively between two spring legs. As an alternative or in addition, the boss can serve as a stop in the fitting direction between the spring clip and the mechanism housing, in particular if a radially outer region of the boss rests on the web of the spring clip.

As compared with connection of the housing halves by means of screws or by means of riveted joints, the installation space required for the screwed joint or riveted joint is saved in the connection according to the invention having clip elements designed as spring clips. As a result, the housing parts become smaller and less expensive. Moreover, the complex screwing process is replaced by a simpler push-on process for the clip elements. It is thereby possible to save on cycle time and to work with simpler equipment. There is no need to provide a multiple screwing station.

The invention is explained in greater detail below by means of an advantageous illustrative embodiment shown in the figures. However, the invention is not restricted to this illustrative embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is an exploded view of a seat adjustment mechanism according to the prior art;

FIG. 2 is a perspective view of a mechanism housing according to the invention;

FIG. 3 is a view corresponding to FIG. 2 of the mechanism housing before the installation of spring clips; and

FIG. 4 is an isolated view of a spring clip from FIG. 3.

### DESCRIPTION OF THE PREFERRED EMBODIMENTS

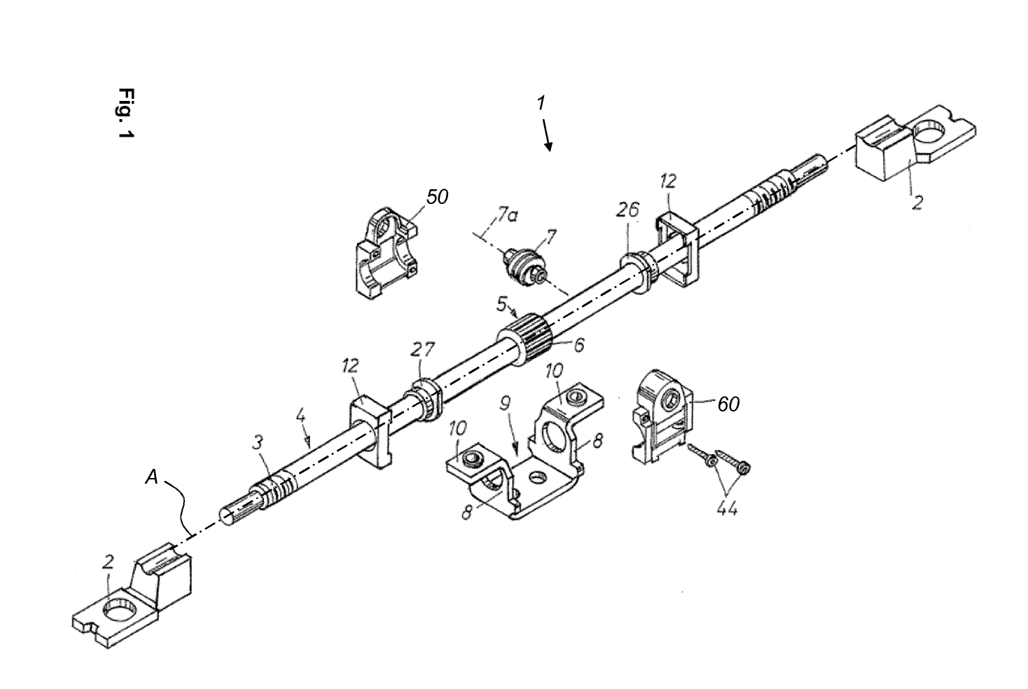

Referring to the drawings, FIG. 1 shows a mechanism 1, known from the prior art, for longitudinal seat adjustment of a motor vehicle seat. It is preferably situated between a bottom and a top rail and is part of a longitudinal adjuster known per se, the fundamental construction of which is known from DE 10 2004 001 624 B3, for example. In this case, the bottom rail is fixed on a floor structure of a motor vehicle, while the top rail is arranged on the seat and can be adjusted longitudinally with the latter relative to the bottom rail. The two rails can be supported on one another by means of a sliding bearing assembly or by rolling elements. This basic construction of a longitudinal adjuster is already known per se and is not shown in detail in FIG. 1.

Two end-located spindle holders 2 are attached to the bottom rail. A spindle 4 provided with a thread 3 is mounted in a manner fixed against rotation in the two spindle holders 2. In FIG. 1, the thread 3 is not fully shown for the sake of clarity. The center line of the spindle 4 in the direction of its longitudinal extent is referred to below as axis A. When installed in a motor vehicle, the axis A extends largely parallel to the direction of travel. The axis A defines the direction data, used below, of a cylindrical coordinate system.

A spindle nut 5 is screwed onto the spindle 4. On its circumferential surface, the spindle nut 5 has helical toothing 6, which is in mesh with a worm 7. The axis A of the spindle 4 and an axis of rotation 7a of the worm 7 run perpendicular to one another here. The worm 7 is driven by an electric drive motor (not shown specifically). Instead of a drive motor, a manual actuating system could also be provided. The spindle 4 is passed through two mutually parallel legs 8 of a substantially U-shaped retention strap 9. Adjoining each leg 8 is a fastening leg 10, by means of which the retention strap 9 is mounted on the top rail. The fastening legs 10 are bent through about 90° relative to their respective leg 8.

Accommodated in the U-shaped retention strap 9 is a mechanism housing, which is framed by two dampers 12. In this arrangement, each of the dampers 12 is situated between the mechanism housing and one of the legs 8. By means of the dampers 12, the transmission of possible vibrations of the adjustment mechanism 1 to the top rail is prevented, and therefore troublesome noise generation is also suppressed.

The mechanism housing consists of two shell-shaped housing parts 50, 60, namely a first housing part 50 and a second housing part 60. The longitudinal axis of the spindle 4 is situated approximately in a stepped dividing surface of the housing, at which the two housing parts 50, 60 abut by means of a respective contact surface. Moreover, the axis of rotation 7a of the worm 7 extends perpendicularly to the dividing surface. Between them, the two housing parts 50, 60 form an accommodation space in which a section of the spindle 4, the spindle nut 5, the worm 7 and two bearing bushes 26, 27 are arranged. Since the width of the accommodation space is less than the diameter of the spindle nut 5, each of the housing parts 50, 60 has an aperture in the region of its side walls. Moreover, the housing parts 50, 60 each have two opposing semicircular notches in the region of the dividing surface, each pair of notches forming an aperture through which the spindle 4 is passed. Arranged in each of the apertures is a bearing bush 26, 27, in which the spindle nut 5 is mounted.

There are likewise respective apertures in the upper semicircular extensions of the housing parts 50, 60. These apertures serve to receive the worm 7, which can be mounted by means of bearing bushes in the housing parts 50, 60. In the assembled state, the housing parts 50, 60 are pressed against one another by means of their stepped contact surfaces in the region of the dividing surface.

The contact surfaces are largely flat with individual steps and thereby form a kind of nested structure comprising shoulders and undercuts. By means of the nesting, the position of the two housing parts 50, 60 relative to one another in respect of their mutual alignment is predetermined.

In order to connect the two housing parts 50, 60 to one another, two screws 44 are provided, which lie diagonally opposite one another in relation to the accommodation space. In other embodiments of the prior art, there is only a single screwed joint or, alternatively, there are three or more screwed joints.

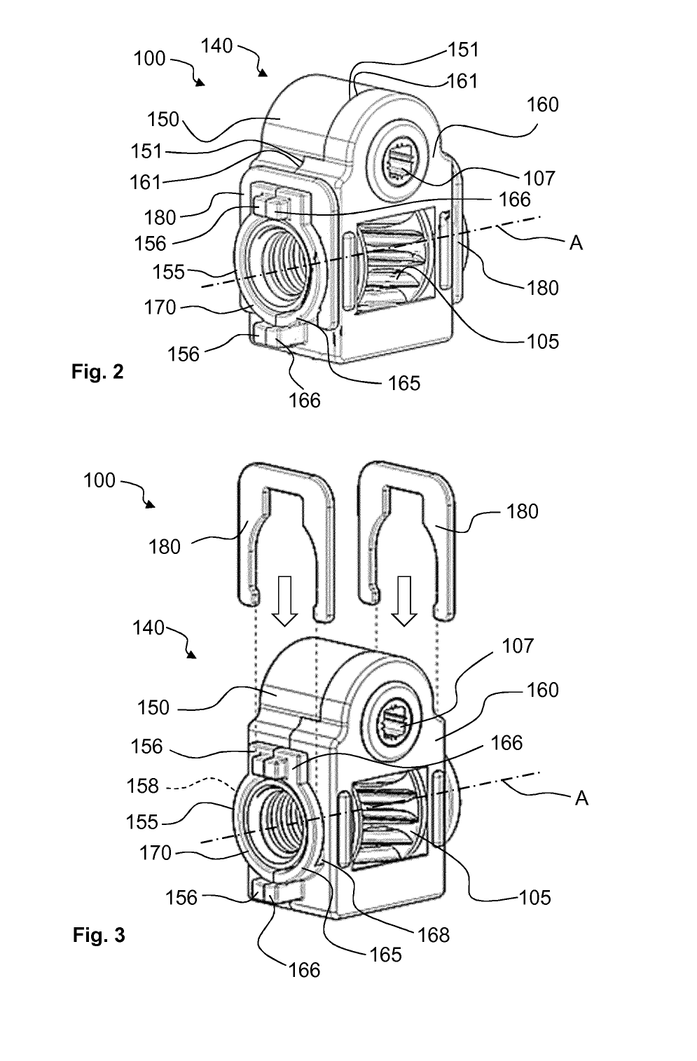

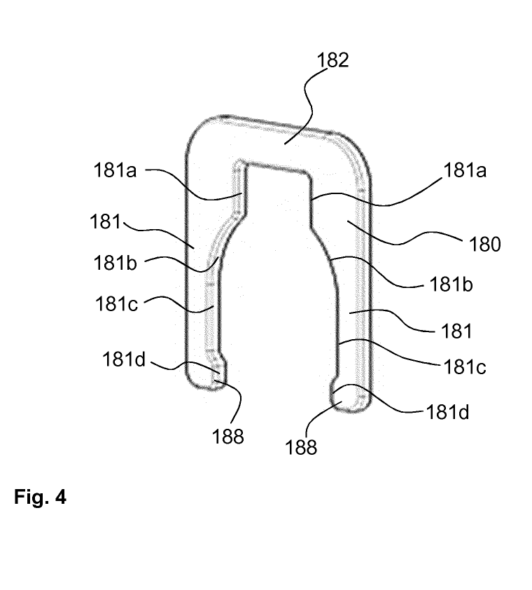

FIGS. 2 and 3 show a mechanism housing 140 according to the invention for a seat adjustment mechanism for a motor vehicle, the basic construction of which, unless described otherwise, corresponds to the mechanism housing shown in FIG. 1 and described above and which is part of an adjustment mechanism 100, e.g. for longitudinal seat adjustment of a motor vehicle seat.

The mechanism housing 140 comprises a first housing part 150 and a second housing part 160, which define between them an accommodation space, in particular for a spindle nut 105 extending in the direction of the axis A and a worm 107 extending perpendicularly to the axis A. The housing parts 150, 160 rest against one another in a radial, mutually facing direction by means of complementary stepped contact surfaces 151, 161 and surround the axis A. In an axial direction, the two housing parts 150, 160 are fixed relative to one another by means of steps in the stepped contact surfaces 151, 161. In a radial direction facing away from one another, however, the two housing parts 150, 160 are not screwed together, in contrast to the prior-art mechanism housing described above, but are fixed relative to one another by two spring clips 180. The two spring clips 180 fix the housing parts 150, 160 in a direction oriented perpendicularly to the contact surfaces 151, 161.

The first housing part 150 has a substantially semicircular first cylindrical segment 155 at each of its two ends situated opposite one another in the axial direction. The second housing part 160 too has a substantially semicircular second cylindrical segment 165 at each of its two ends situated opposite one another in the axial direction. A first boss 156 projects in a radial direction from each of the two ends of the first cylindrical segment 155 as viewed in the circumferential direction. A second boss 166 projects in a radial direction from each of the two ends of the second cylindrical segment 165 as viewed in the circumferential direction.

A respective first cylindrical segment 155 of the first housing part 150 and a respective second cylindrical segment 165 of the second housing part 160 rest against one another as a pair to form a cylindrical portion 170, through which the spindle 4 can be passed.

The cylinder centerlines of the two cylindrical portions 170 coincide with the axis A. The mechanism housing 140 and hence also the cylindrical portions 170 are largely mirror-symmetrical with respect to a plane of symmetry extending perpendicularly to the axis A. Mounted in each of the two cylindrical portions 170 there is furthermore the spindle nut 105, preferably with the interposition of respective bearing bushes.

Each of the two cylindrical portions 170 forms a shoulder 170 which projects outward from the mechanism housing 140 in the direction of the axis A.

A first boss 156 and a second boss 166 in each case rest on one another and together form a boss region projecting from the cylindrical portion 170 in a radial direction. Two boss regions project in a radial direction from each cylindrical portion 170, being situated diametrically opposite one another. The boss regions are of approximately cuboidal design.

The first cylindrical segment 155 has a first depression 158, which is arranged in a region of the first cylindrical segment 155 which faces the center of the mechanism housing 140. The second cylindrical segment 165 has a second depression 168, which is arranged in a region of the second cylindrical segment 165 facing the center of the mechanism housing 140. The two depressions 158, 168 are situated opposite one another and, in a plane extending perpendicularly to the axis A, together form a quadrilateral undercut in the cylindrical portion 170. In the axial direction, the two depressions 158, 168 are each bounded by two lateral surfaces, which extend perpendicularly to the axis A and are spaced apart parallel to one another by a width of the depression. The width of the depression in the axial direction corresponds approximately to the material thickness of the spring clip 180.

The two spring clips 180 are configured as common parts or mirror-symmetrical parts, and therefore only one of the two spring clips 180 is described below.

The spring clip 180 has a flat U-shaped basic shape. In the present case, the spring clip 180 is punched out of a spring sheet, but could also be manufactured from some other material or from a spring wire. Two spring legs 181 are connected to one another by means of a web 182.

The mutually opposite sides of the two spring legs 181 are of contoured design. The two spring legs 181 are mirror-symmetrical with respect to one another, namely in relation to a plane of symmetry which extends perpendicularly through the web 182. In a first region 181a adjacent to the web 182, the inner contours of the two spring legs 181 first of all extend parallel to one another. In a second region 181b adjoining the first region 181a, the two spring legs 181 are each of arc-shaped configuration, with the result that the clear width between the spring legs 181 increases in the second region 18 lb. In a third region 181c adjoining the second region 181b, the inner contours of the two spring legs 181 once again extend parallel to one another but at a larger distance than in the first region 181a. In a fourth region 181d adjoining the third region 181c, each of the two spring legs 181 has a nose 188. The two noses 188 are oriented toward one another. The distance between the two noses 188 is less than the clear width between the two spring legs 181 in the third region 181c.

The two spring clips 180 fix the housing parts 150, 160 relative to one another. The fixing is explained below by means of one of the two spring clips 180. The additional fixing by the second spring clip 180 is accomplished in the same way.

Since one of the two spring legs 181 engages in the first depression 158 and the other of the two spring legs 181 engages in the second depression 168 and, as a result, the spring clip 180 fits around the cylindrical portion 170, the two housing parts 150, 160 cannot move away from one another.

During the assembly of the mechanism housing 140, the spring clips 180 are pushed onto the cylindrical portions 170. The fitting direction is indicated by two arrows in FIG. 3. Pushing the spring clips 180 onto the cylindrical portions 170 causes the two spring legs 181 initially to spread apart resiliently somewhat. During this process, the two noses 188 run over the bottom of the depressions 158, 168 until the noses 188, after passing through the depressions 158, 168, can move toward one another again. The two noses 188 then engage behind that region of the cylindrical portions 170 which is situated behind the depressions 158, 168 in the fitting direction.

In the assembled state of the mechanism housing 140, that is to say after the two spring clips 180 have been pushed on, one of the two cuboidal boss regions formed by the first boss 156 and the second boss 166 lies in positive engagement between the two first regions 181a of the spring clip 180, and therefore the spring clip 180 cannot rotate about the associated cylindrical portion 170. The two third regions 181c of the spring legs 181 in each case rest in a radial direction on the bottom of one of the depressions 158, 168. In the axial direction, the two third regions 181c of the spring legs 181 in each case lie between the two lateral surfaces of one of the two depressions 158, 168.

The features disclosed in the present description, the claims and the drawings can be of significance for the implementation of the invention in its various embodiments both individually and in combination.

While specific embodiments of the invention have been shown and described in detail to illustrate the application of the principles of the invention, it will be understood that the invention may be embodied otherwise without departing from such principles.

1. A mechanism housing for an adjustment mechanism for a vehicle seat, the mechanism housing comprising:
two spring clips;
a first housing part and
a second housing part, wherein a first cylindrical segment of the first housing part and a second cylindrical segment of the second housing part rest against one another as a pair to form a cylindrical portion through which a spindle extending in the direction of an axis can be passed, wherein, in a radial direction relative to the axis, facing away from each other, the two housing parts are fixed relative to one another by means of the two spring clips.

2. The mechanism housing as claimed in claim 1, wherein the mechanism housing forms an accommodation space for a spindle nut, which can be rotated about an axis, and a worm, which drives the spindle nut.

3. The mechanism housing as claimed in claim 1, wherein at least one of the spring clips engages around the cylindrical portion, wherein the cylindrical portion is composed of at least two cylindrical segments and each of the two cylindrical segments is formed integrally on a different one of the two housing parts.

4. The mechanism housing as claimed in claim 1, wherein at least one of the spring clips is punched out of a spring sheet.

5. The mechanism housing as claimed in claim 1, wherein at least one of the spring clips is manufactured from a spring wire.

6. The mechanism housing as claimed in claim 1, wherein at least one of the spring clips has a flat U-shaped basic shape.

7. The mechanism housing as claimed in claim 1, wherein at least one of the spring clips has an arched shape.

8. The mechanism housing as claimed in claim 7, wherein that at least one of the spring clips has a wave shape.

9. The mechanism housing as claimed in claim 1, wherein at least one of the spring clips has two spring legs that are connected to one another by a web.

10. The mechanism housing as claimed in claim 9, wherein that the two spring legs are formed in mirror symmetry with respect to one another.

11. The mechanism housing as claimed in claim 9, wherein at least one of the two spring legs has a nose on an end remote from the web, said nose fixing the spring clip counter to a fitting direction of the spring clip.

12. The mechanism housing as claimed in claim 9, wherein the two spring legs engage in depressions in the cylindrical portion.

13. The mechanism housing as claimed in claim 9, wherein the two spring legs enclose between them a boss region in such a way that the boss region prevents twisting of the spring clip about the axis.

14. The mechanism housing as claimed in claim 13, wherein the first boss and/or the second boss serve/serves as a stop in the fitting direction between the spring clip and the mechanism housing.

15. The mechanism housing as claimed in claim 14, wherein a radially outer region of the first boss and/or of the second boss rests on the web of the spring clip.
